(19) United States
(12) Patent Application Publication
(10) Pub. No.: US 2021/0202134 A1
(43) Pub. Date: Jul. 1, 2021

(54) POLY (ARYL ETHERKETONE) BASED VARNISH FOR WIRE COATING AND METHOD COATING A WIRE FROM A SOLUTION

(71) Applicant: Arkema Inc., king of Prussia, PA (US)

(72) Inventors: Julien JOUANNEAU, Bryn Mawr, PA (US); Timothy A. SPAHR, Galesville, WI (US); Jean-Alex LAFFITTE, Biarritz (FR)

(21) Appl. No.: 16/650,421

(22) PCT Filed: Sep. 24, 2018
(86) PCT No.: PCT/US18/52368

§ 371 Date: Mar. 25, 2020

Related U.S. Application Data
(60) Provisional application No. 62/564,328, filed on Sep. 28, 2017.

(51) Int. Cl. H01B 13/16; H01B 13/06; H01B 3/36; H01B 3/42; H01B 7/02; C08G 65/40; C08K 5/136

(52) U.S. Cl. CPC H01B 13/165; H01B 13/065; H01B 3/36; H01B 3/427; C08G 2650/40; H01B 7/0225; C08G 65/4012; C08K 5/136; H01B 7/0216

(57) ABSTRACT

A method of manufacturing a coated metallic wire having a polymeric coating, the method includes: dissolving at least one polymer including a poly(aryl etherketone) in at least one phenolic solvent to form a solution; contacting the surface of a metallic wire with the solution to form a coated wire having at least one layer of coating; and drying the coated wire to evaporate residual solvent.

### FIELD OF THE INVENTION

Embodiments of the invention relate to methods of manufacturing a coated wire from a varnish containing poly(aryl etherketones), such as polyetherketoneketone (PEKK) and polyetheretherketone (PEEK), dissolved in a phenolic solvent.

### BACKGROUND OF THE INVENTION

High-temperature resistant wires and cables are of great significance in a variety of industries, including the electric motor industry. Currently, varnishes of polyimide, polyamideimide and polyesterimide are being implemented in the design of wires used in electromagnetic coils for motors. These materials, however, are sensitive to moisture. Thus, coatings of these materials are subject to degradation in high humidity environments, resulting in unsatisfactory insulation.

Poly(aryl etherketones), such as poly(etherketoneketone) (PEKK), and poly(etheretherketone) (PEEK), exhibit high-temperature resistances without having the drawback of moisture sensitivity. PEEK coated wires are known; however, current PEEK coated wires on the market are not satisfactory for use in certain applications, e.g., as electromagnetic coils for motors. Known PEEK coated wires are manufactured by a melt extrusion process which is not able to provide a suitably thinly coated wire with a low level of defect that can be used in a magnet wire application.

US 2014/0088234 A1 relates to films and membranes of poly(aryl ketones), such as poly(etherketoneketone) (PEKK), and methods of making the films and membranes by using a solvent cast process.

WO 2017/153290 relates to polyarylether ketone compositions and methods of coating a metal surface using melt extrusion processes.

There remains a need for a coating that is high-temperature resistance, low-sensitivity to moisture, and good abrasion resistance which is capable of being used to form a thinly coated wire suitable for magnet wire applications, e.g., such as within an electromagnetic coil of an electric motor.

### SUMMARY OF THE INVENTION

Embodiments of the present invention provide for a coating for wires comprising poly(aryl etherketones), such as poly(etherketoneketone) (PEKK), and poly(etheretherketone) (PEEK), and associated methods of making the same using a phenolic solvent. In particular, at least one poly(aryl etherketone) is combined in a specific solvent or solvent system with other optional ingredients, such as other polymers, carbon nanotubes, colorants, dyes, polymer additives, and organic or inorganic fillers, to produce specialized coatings with enhanced mechanical properties (rigidity, durability, strength, etc.), chemical resistance, flame retardancy, and/or electrical properties, for example. These specialized coatings are especially suitable in engineering applications, such as aerospace, aircraft, electronics, building and construction, photovoltaic, oil and gas and the like.

An advantage of embodiments of the present invention is that embodiments may provide for a coated wire having good adhesion between the metallic wire and the coating, which is not highly sensitive to moisture and has good abrasion resistance. Another advantage of embodiments the present invention is that embodiments may provide for a better consistency of coating with respect to thickness and defect content (e.g., the formation of gels, presence of foreign particles, black spec, etc.), enable the production of coated wires having an extremely thin coating or thin layers of coating (e.g., less than 20 microns), enable multi-layer coatings, and decrease the risk of dielectric failure of the wires in comparison to wires coated by extrusion methods. Embodiments of the invention are directed to methods of coating that do not include melt-extrusion coating.

An advantage of embodiments of the present invention is components/additives that are not capable of withstanding the conditions of melt processing needed for poly(aryl ketones) (such as temperatures) can be incorporated into to a solution of an embodiment of the present invention at a temperature, for example, below the boiling point of the solvent or at ambient conditions.

In comparison with melt extrusion processes for manufacturing poly(aryl etherketone) coated wires, embodiments of the processes described herein enable the use of higher molecular weight polymers, thus improving the mechanical properties of the coated wires described herein and providing for better chemical resistance over previously existing poly(aryl etherketone) coated wires. A commonly used measurement of the molecular weight of poly(aryl etherketones) is their inherent viscosity in 96% sulfuric acid (as measured by ISO 307). Melt extrusion produced wires, for instance, having thin coatings, are generally limited to poly(aryl etherketones) having an inherent viscosity below 1.2 dL/g. Embodiments of the presently described processes may enable the manufacture of thinly coated wires having coatings comprising poly(aryl etherketones) having inherent viscosities of up to about 2.5 dL/g. For example, embodiments may include coatings comprising poly(aryl etherketones) having inherent viscosities of at least 1.2 dL/g, for example, 1.4 dL/g to 2.5 dL/g, for example, 1.6 dL/g to 2.5 dL/g or 1.6 dL/g to 2.0 dL/g. In is some such embodiments or in other embodiments, at least one coating may comprise a poly(aryl etherketone) having an inherent viscosity of less than 1.2 dL/g. Additionally, in comparison with melt extrusion processes for manufacturing poly(aryl etherketone) coated wires, embodiments of the processes described herein enable the production of multiply-layered wire coatings.

According to an embodiment of the present invention, a method of manufacturing a coated wire includes: dissolving at least one polymer comprising a poly(aryl etherketone) in at least one phenolic solvent to form a solution; contacting the surface of a wire with the solution to form a coated wire having at least one layer of coating; and drying the coated wire to evaporate residual solvent. The process can thus be repeated as much as needed to obtain the targeted thickness.

According to another embodiment of the present invention, the solution may include additional components such as polymers, additives (e.g., core-shell impact modifiers), fillers (e.g., carbon nanotubes), and mixtures thereof.

The polymer comprising the poly(aryl etherketone) dissolved in the phenolic solution may be selected from the group of poly(etherketoneketone) (PEKK), poly(etheretherketone) (PEEK), polyetherketoneetherketoneketone (PEKEKK), poly(etherketone) (PEK), and mixtures thereof. Preferably the polymer comprises PEKK and/or PEEK. According to some embodiments, the polymer may be PEKK and may have a T:I isomer ratio within a range of 50/50 to 85/15.

The phenolic solvent may be comprised of solvents such as 4-chloro-2-methyl phenol (4-Cl-o-cresol), 4-chloro-3-methyl phenol (4-Cl-m-cresol), 3-chloro phenol, 4-chloro-phenol, 4-methyl-phenol (p-cresol). In embodiments, the solvent of the present invention may comprise mixtures of 4-chloro phenol and 0 to about 50 weight percent 4-chloro-3-methyl phenol (4-Cl-m-cresol) based on the total weight of the solvent. In a preferred embodiment, the solvent may comprise about 5 to 20 weight percent, preferably about 5 to 15 weight percent, more preferably about 10 weight percent 4-chloro phenol and about 80 to 95 weight percent, preferably about 85 to 95 percent, more preferably about 90 percent 4-chloro-3-methyl phenol.

In embodiments, the coated wire has a metallic core. For instance, the wire subjected to the coating process may comprise copper or aluminum or any corresponding alloy. In embodiments, the wire may further comprise a primer (e.g., to promote adhesion of the coating). In embodiments, the coated wire and/or wire core may have a cross-sectional shape of a polygon, circle, oval, square or rectangle.

In embodiments, the contacting step may comprise dipping the wire into the solution or spraying the wire with the solution. In embodiments, the step of drying the coated wire to evaporate residual solvent may take place at a temperature of 250° C. to 420° C., preferably between 300 and 360 C. In embodiments, at least 70% or 80% of the solvent is evaporated (e.g., prior to dipping the coated wire in a same or a different dope to form a next layer of coating, etc.). In some embodiments at least 90%, 95% or 99% of the solvent is evaporated. Nitrogen or air swipe can be applied to speed up the drying step. Optionally, a vacuum can be applied during the drying step.

Embodiments of the method may yield a coated wire having multiple layers of coating. Each layer of coating may be the same as or different from another layer of coating. In some embodiments, the thickness of coating obtained after one pass (e.g., one layer of coating) may have a thickness of about 0.5 to 2 microns. In some embodiments, a coated wire may be subjected to a coating process to form one or more additional layers thereupon (e.g., by contacting the surface of the coated wire with a solution to form an additional layer and drying the coated wire having the additional layer).

In some embodiments, the method of manufacturing the coated wire may comprise a filtering step to filter the solution to remove impurities, such as gels, insoluble particles, dust, etc. The filtering step may be performed prior to contacting the surface of the wire (or the coated wire) with a solution.

In embodiments, the at least one polymer may be dissolved in the solvent at temperatures between 20° C. and 160° C., preferably at temperatures between 50° C. and 100° C.

Optionally, the resulting coated wire may also undergo suitable post-treatments, for example, to develop specific properties, such as crystallinity.

### DETAILED DESCRIPTION OF THE INVENTION

Aspects of the present invention include coated wires having at least one layer of coating comprising poly(aryl ketones) and methods of manufacturing a coated wire is from a varnish containing poly(aryl etherketone), such as polyetherketoneketone (PEKK) and polyetheretherketone (PEEK), dissolved in a phenolic solvent.

As used herein, “coatings” are thin layers, skins, or coverings which are well known to those of ordinary skill in the art. The coatings are adhered to a cable or wire. The coatings may be non-porous, porous, microporous, etc., depending on the application and use. The thicknesses of the coatings are unlimited and may be any suitable thickness. For example, the coatings may range from about 1 nm (0.001 μm) to 1500 μm in thickness, e.g., about 0.25 μm to about 250 μm in thickness. For some applications, the coatings may have a thickness of about 0.5 μm to about 2 μm. The total coating thickness (i.e., of all layer(s) of coating on a wire) of a coated wire obtained by the processes described herein may be within the range of 10 to 1500 μm, preferably 10 to 200 μm, more preferably 10 to 60 μm.

As used herein, a “solution,” “varnish,” or a “dope” is a solution containing at least one solvent and dissolved polymer(s) (and other optional ingredients). The terms “dope,” “varnish,” and “solution” may be used interchangeably w herein. Dopes are also well recognized in fiber chemistry and used in spinning processes to produce fibers. The dissolved polymer(s) may be fully dissolved or partially dissolved. In one embodiment, the polymer(s) are fully dissolved to form a homogenous mixture of the polymer(s) (e.g., the solute) dissolved in the at least one solvent. The other optional ingredients may also be fully or partially dissolved or, alternatively, may be suspended in the dope. For example, the other optional ingredients may form a suspension in the dope, where solid particles, such as carbon nanotubes, are suspended or, alternatively, may precipitate out or form different concentrations within the dope.

As used herein, each compound may be discussed interchangeably with respect to its chemical formula, chemical name, abbreviation, etc. For example, PEKK may be used interchangeably with poly(etherketoneketone). Additionally, each compound described herein, unless designated otherwise, includes homopolymers and copolymers. The term “copolymers” is meant to include polymers containing two or more different monomers and can include, for example, polymers is containing two, three or four different repeating monomer units.

Unless specified otherwise, the values of the constituents or components of the compositions are expressed in weight percent or % by weight of each ingredient in the composition. All values provided herein include up to and including the endpoints given.

As used herein and in the claims, the terms “comprising” and “including” are inclusive or open-ended and do not exclude additional unrecited elements, compositional components, or method steps. Accordingly, the terms “comprising” and “including” encompass the more restrictive terms “consisting essentially of” and “consisting of”

According to an aspect of the present invention, a method of manufacturing a coated wire includes: dissolving at least one polymer comprising a poly(aryl etherketone) in at least one phenolic solvent to form a solution; contacting the surface of a wire with the solution to form a coated wire having at least one layer of coating; and drying the coated wire to evaporate residual solvent.

At least one polymer is dissolved in at least one solvent to form a solution. The polymer may include thermoplastic polymers, including poly(aryl ketones), such as polyetherketoneketone (PEKK), polyetheretherketone (PEEK), and the like, which may be in any suitable form. For example, the polymers may be in solid form, such as pellets, flakes, powders, granules, chips, etc. The form of the polymer may be unlimited. Different polymers may be added in different states, which could be determined by one of ordinary skill in the art. In one embodiment, the poly(aryl etherketone) polymer is added in a solid form.

The polymer comprises or consists of at least one poly(aryl ketone). Poly(aryl ketones) are intended to encompass all homopolymers and copolymers (including e.g., terpolymers) and the like. In one embodiment, the poly(aryl etherketone) is selected from the group consisting of polyetherketoneketone (PEKK), polyetheretherketone (PEEK), polyetherketone (PEK), polyetherketoneetherketoneketone (PEKEKK), and mixtures thereof.

In one embodiment, the poly(aryl etherketone) comprises polyetherketoneketone (PEKK). Polyetherketoneketones suitable for use in embodiments of the present invention may comprise or consist essentially of repeating units represented by the following formulas I and II:

-A-C(═O)—B—C(═O)— I

-A-C(═O)-D-C(═O)— II

where A is a p,p′-Ph—O—Ph—group, Ph is a phenylene radical, B is p-phenylene, and D is m-phenylene. The Formula I:Formula II (T:I) isomer ratio in the polyetherketoneketone can range from 100:0 to 0:100. The isomer ratio may be easily varied as may be desired to achieve a certain set of properties, e.g., by varying the relative amounts of the different monomers used to prepare the polyetherketoneketone. Generally, a polyetherketoneketone having a relatively high Formula I:Formula II ratio will be more crystalline than a polyetherketoneketone having a lower Formula I:Formula II ratio. Thus, the T:I ratio may be adjusted so as to provide an amorphous (non-crystalline) polyetherketoneketone or a more crystalline polyetherketoneketone, as desired. In one embodiment, a polyetherketoneketone having a T:I isomer ratio of from about 50:50 to about 90:10 may be employed.

For example, the chemical structure for a polyetherketoneketone with all para-phenylene linkages [PEKK(T)] may be represented by formula III:

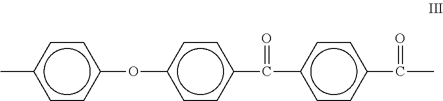

The chemical structure for a polyetherketoneketone with one meta-phenylene linkage in the backbone [PEKK(I)] may be represented by formula IV:

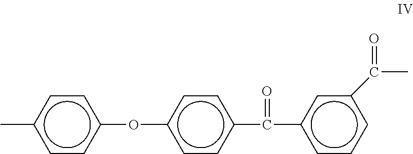

The chemical structure for a polyetherketoneketone with alternating T and I isomers, e.g., a homopolymer having 50% chemical compositions of both T and I [PEKK(T/I)] may be represented by formula V:

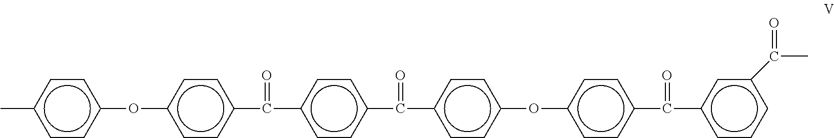

In another embodiment, the poly(aryl etherketone) comprises polyetheretherketone (PEEK). Polyetheretherketones suitable for use in the present invention may comprise or consist essentially of repeating units (n≥1) represented by formula VI:

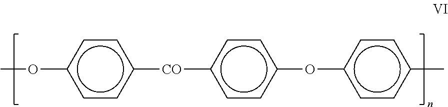

In another embodiment, the poly(aryl etherketone) comprises polyetherketone (PEK). Polyetherketones suitable for use in the present invention may comprise or consist essentially of repeating units (n≥1) represented by formula VII:

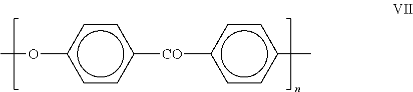

The poly(aryl etherketones) may be prepared by any suitable method, which is well known in the art. For example, a poly(aryl etherketone) may be formed by heating a substantially equimolar mixture of at least one bisphenol and at least one dihalobenzoid compound or at least one halophenol compound. The polymer may be amorphous or crystallized, which can be controlled through synthesis of the polymer. Thus, the polymer(s) and resulting coatings may run the spectrum from non-crystalline to highly crystalline depending on the intended use and industrial application for the coated wire. Additionally, the polymer(s) may also be of any suitable molecular weight and may be functionalized or sulfonated, if desired. In one embodiment, the polymer(s) undergo sulfonation or any example of surface modification known to one skilled in the art.

Suitable polyetherketoneketones are available from several commercial sources under various brand names. For example, Polyetherketoneketone polymers is are manufactured and supplied by Arkema under the brand name Kepstan™.

The solution may include other polymers, in addition to the poly(aryl etherketone). In one embodiment, the other polymers share similar melting temperatures, melt stabilities, etc. and are compatible by exhibiting complete or partial miscibility with one another. In particular, other polymers exhibiting mechanical compatibility with the poly(aryl etherketone) may be added to the composition. It is also envisioned, however, that the polymers need not be compatible with the poly(aryl etherketone) and may not readily dissolve in the solvent (e.g., the other polymer may be a filler in suspension). The other polymers may include, for example, polyamides (such as poly(hexamethylene adipamide) or poly(ε-caproamide)); polyimides (such as polyetherimide (PEI), thermoplastic polyimide (TPI), and polybenzimidazole (PBI)); polysulfones/sulfides (such as polyphenylene sulfide (PPS), polyphenylene sulfone (PPSO₂), polyethersulfone (PES), and polyphenylsulfone (PPSU)); poly(aryl ethers); and polyacrylonitrile (PAN). In one embodiment, the other polymers include polyamide polymers and copolymers, polyimide polymers and copolymers, etc. Polyamide polymers may be particularly suitable in high temperature applications. The additional polymers may be blended with the poly(aryl etherketone) by conventional methods.

The polymer is dissolved in at least one solvent. Conventionally, many or most poly(aryl ketones) do not dissolve in most solvents, and it was previously very difficult to make poly(aryl ketones) into solutions. In the present disclosure, certain solvents or solvent systems were discovered to be particularly effective and suitable for dissolving poly(aryl etherketone) polymers to form dopes, and more specifically, were found to be particularly useful for forming specialized coatings having low defect content and good consistency at thicknesses which are not obtainable by previously known methods of coating wires with poly(aryl ketones).

The solvent used may be selected from solvents which effectively dissolve the polymer (e.g., the poly(aryl ketone)).

In one embodiment, the solvent comprises at least one aromatic solvent such as 4-chloro-2-methyl phenol (4-Cl-o-cresol), 4-chloro-3-methyl phenol (4-Cl-m-cresol), 3-chloro phenol, 4-chloro-phenol, 4-methyl-phenol (p-cresol). Thus, the solvent may include a mixture of these solvents, such as a mixture of 4-chloro-phenol and 4-chloro-3-methyl phenol (4-Cl-m-cresol). In one embodiment, the solvent includes from about 50 weight percent to about 100 weight percent of 4-chloro-phenol and 0 to about 50 weight percent 4-chloro-3-methyl phenol (4-Cl-m-cresol) based on the total weight of the solvent.

In one embodiment, the solvent comprises a mixture of aromatic solvents such as 4-chloro-2-methyl phenol (4-Cl-o-cresol), 4-chloro-3-methyl phenol (4-Cl-m-cresol), 3-chloro phenol, 4-chloro-phenol, 4-methyl-phenol (p-cresol) and ortho dichlorobenzene (ODCB). Thus, the solvent may include a mixture of these solvents, such as a mixture of 4-chloro-phenol, 4-chloro-3-methyl phenol (4-Cl-m-cresol) and ortho dichlorobenzene (ODCB). In one embodiment, the solvent includes from about 5 weight percent to about 90 weight percent of 4-chloro-phenol, 0.5 to about 20 weight percent 4-chloro-3-methyl phenol (4-Cl-m-cresol) and 0 to about 90 weight percent ortho dichlorobenzene (ODCB), based on the total weight of the solvent.

The solvent may also include additional component(s) such as additional polymers; additives, such as core-shell impact modifiers; fillers or reinforcing agents, such as glass fibers; carbon fibers; plasticizers; pigments or dyes; thermal stabilizers; ultraviolet light stabilizers or absorbers; antioxidants; processing aids or lubricants; flame retardant synergists, such as Sb₂O₃, zinc borate, and the like; or mixtures thereof. These components may optionally be present, for example, in an amount of about 0.1 weight percent to about 70 weight percent, preferably 5 to 40 weight percent, more preferably 10 to 25 weight percent based on the total weight of the dope composition. As previously discussed, the dope may include additional polymers. The additional polymers may be dissolved within the dope or may be selected to be solid particles which do not dissolve in the dope.

The solution may also include additives, such as core-shell impact modifiers. These additives may optionally be present in an amount of from about 0.1 weight percent to about 70, preferably 5 to 40, more preferably 10 to 25, based on the total weight of the dope composition. The core-shell impact modifiers may include multi-layer polymers and block copolymers having at least one hard and at least one soft block (e.g., a soft rubber or elastomeric core and a hard shell or a hard core covered with a soft elastomeric layer and a hard shell). For example, the soft blocks or rubber layers may be composed of low glass transition (Tg) polymers, such as polymers of butyl acrylate (BA), ethylhexyl acrylate (EHA), butadiene (BD), BD/styrene, butylacrylate/styrene, etc. or combinations thereof. The hard blocks or layers may be composed of any suitable polymers, such as polymers of methyl methacrylate (MMA), ethyl acrylate (EA), allyl methacrylate, styrene or combinations thereof, for example. The core-shell impact modifiers may be of any suitable size and shape. For example, the particles may have a particle size ranging from about 2 nm to about 700 nm, preferably from about 50 to 500 nm, more preferably from about 100 to 400 nm.

Suitable fillers may include fibers, powders, flakes, etc. For example, fillers may include at least one of carbon nanotubes, carbon fibers, glass fibers, polyamide fibers, hydroxyapatite, aluminum oxides, titanium oxides, aluminum nitride, silica, alumina, barium sulfates, etc. The size and shape of the fillers are also not particularly limited. Such fillers may be optionally present in an amount of from about 0.1 weight percent to about 70, preferably 5 to 40 weight percent, more preferably 10 to 25 weight percent.

In one embodiment, the dope comprises carbon nanotubes (CNT). Carbon nanotubes are allotropes of carbon with a cylindrical nanostructure. The nanotubes may be single-walled or multi-walled; functionalized; coated; or modified in any suitable way. Also, the nanotubes may have any suitable length-to-diameter ratio as needed for the desired properties of the resulting coated wires. The dope composition may include any suitable amount of carbon nanotubes as preferred for the application. For example, the dope may include from trace amounts up to 2 weight percent carbon nanotubes, e.g., from about 0.0.001 weight percent to about 2 weight percent carbon nanotubes. Where coatings are formed from a dope comprising carbon nanotubes, they may be such that the amount of carbon nanotube in the coating remains below the electrical percolation threshold and consequently does not increase significantly the electric conductivity of the coated wire.

In another embodiment, the dope used to form the coating includes a poly(aryl etherketone) polymer, e.g., PEKK, which is at least partially or fully dissolved in the is solvent. In an embodiment, the dope also includes carbon nanotubes.

The dope, with or without additional component(s), may be prepared by any conventional mixing or agitation methods. For example, a suitable method comprises mixing a solid poly(aryl etherketone) polymer with the solvent(s) at or above room temperature until the polymer is dissolved and the dope is formed, and optionally, adding and mixing a filler, such as carbon nanotubes, with the dope. The additional component(s) may be added to the dope at any suitable time. For example, the additional component(s) may be added when the polymer is added to the solvent. Alternatively, the additional component(s) may be added before or after the dope has been formed.

In one embodiment, the polymer is dissolved at or above ambient/room temperature (e.g., about 20° C. to about 27° C. or about 25° C. at standard conditions). It is not necessary to heat the polymer/solvent mixture to vaporize the solvent(s). The concentration of polymer(s) and other additional components should be selected to provide for a suitable viscosity of the solution to form the dope. For example, the polymer(s) may be present in the dope composition in amounts ranging from about 0.1 weight percent to about 50 weight percent, preferably in the 5 to 40 weight %, more preferably in 10 to 30 weight % range. A person of ordinary skill in the art would be able to select or maintain the appropriate viscosity to process the solution, such as a viscosity of 0.01 to 1000 Pas, 2 to 500 Pas, or 10 to 200 Pas.

In another embodiment, when the solvent comprises at least one aromatic solvent such as 4-chloro-2-methyl phenol (4-Cl-o-cresol), 4-chloro-3-methyl phenol (4-Cl-m-cresol), 3-chloro phenol, 4-chloro-phenol, 4-methyl-phenol (p-cresol), the polymer is dissolved at ambient/room temperature (e.g., about 20° C. to about 27° C. or about 25° C. at standard conditions) and elevated temperatures (e.g., about 75° C. to about 85° C., or higher temperatures about 145° C. to about 155° C.). The concentration of polymer(s) and other additional components should be selected to provide for a suitable viscosity of the solution to form the dope. For example, the polymer(s) may be present in the dope composition in amounts ranging from about 0.1 weight percent to about 50 weight percent, preferably in the 5 to 40 weight % range, more preferably in 10 to 30 weight % range.

In another embodiment, when the solvent comprises of mixtures of aromatic is solvents such as 4-chloro-2-methyl phenol (4-Cl-o-cresol), 4-chloro-3-methyl phenol (4-Cl-m-cresol), 3-chloro phenol, 4-chloro-phenol, 4-methyl-phenol (p-cresol), the polymer is dissolved at ambient/room temperature (e.g., about 20° C. to about 27° C. or about 25° C. at standard conditions) and elevated temperatures (e.g., about 75° C. to about 85° C., or higher temperatures about 145° C. to about 155° C.). In this embodiment the solvent may be comprised of a mixture of 4-chloro-phenol and 4-chloro-3-methyl phenol (4-Cl-m-cresol), including from about 50 weight percent to about 100 weight percent of 4-chloro-phenol and 0 to about 50 weight percent 4-chloro-3-methyl phenol (4-Cl-m-cresol) based on the total weight of the solvent. The concentration of polymer(s) and other additional components should be selected to provide for a suitable viscosity of the solution to form the dope. For example, the polymer(s) may be present in the dope composition in amounts ranging from about 0.1 weight percent to about 50 weight percent, preferably in the 5 to 40%, more preferably in 10 to 30% range.

In another embodiment, when the solvent comprises a mixture of aromatic solvents such as 4-chloro-2-methyl phenol (4-Cl-o-cresol), 4-chloro-3-methyl phenol (4-Cl-m-cresol), 3-chloro phenol, 4-chloro-phenol, 4-methyl-phenol (p-cresol) and ortho dichlorobenzene (ODCB), the polymer is dissolved at ambient/room temperature (e.g., about 20° C. to about 27° C. or about 25° C. at standard conditions) and elevated temperatures (e.g., about 75° C. to about 85° C., or higher temperatures about 145° C. to about 155° C.). In this embodiment the solvent may be comprised of a mixture of 4-chloro-phenol, 4-chloro-3-methyl phenol (4-Cl-m-cresol) and ortho dichlorobenzene (ODCB), including from about 5 weight percent to about 90 weight percent of 4-chloro-phenol, 0.5 to about 10 weight percent 4-chloro-3-methyl phenol (4-Cl-m-cresol) and 0 to about 90 weight percent ortho dichlorobenzene (ODCB), based on the total weight of the solvent. The concentration of polymer(s) and other additional components should be selected to provide for a suitable viscosity of the solution to form the dope. For example, the polymer(s) may be present in the dope composition in amounts ranging from about 0.1 weight percent to about 50 weight percent, preferably in the 5 to 40%, more preferably in 10 to 30% range.

A person of ordinary skill in the art would be able to select or maintain the appropriate viscosity to process the solution.

The solution may be filtered (e.g., prior to application to the wire) to remove impurities.

The solution is deposited on or applied to a wire to form a coating thereon. The coating may be applied substantially uniformly over the entire surface of the wire or a portion thereof. The coating may be applied using any suitable equipment and techniques known in the art. For example, the coating may be applied by dipping the wire into the solution or spraying the coating using, e.g., a spray nozzle.

As used herein, “wire” means one or more cables. The wire is conductive and comprises metal. A “wire” as used herein may refer to a metallic object able to conduct electricity, having a cross-section smaller than about 1 cm², for example smaller than about 0.5 cm², and a ratio of length to diameter of greater than about 100, for example a ratio of greater than about 1000. For instance, the wire may be at least 20% metal, at least 30% wt. metal, at least 40% metal, at least 50% wt. metal, at least 75% wt. metal, at least 90% wt. metal, at least 95 wt. % metal or at least 99 wt. % metal. In embodiments, said metal part is continuous in the wire. The wire may comprise one or more of copper, aluminum, or steel. The wire may be a single core or multi-core wire (e.g., multiple strands twisted together). The wires having a metallic core may be coated, for instance, with a primer to enhance further adhesion to the insulation coating. For example, the wire may be coated with a polyamideimide. The wires can have a cross-section of any shape, including, for example, a circular, oval, square, rectangular, or polygonal cross section.

The coated wire is dried to form a protective layer encapsulating the wire. The coated wire may be dried using any suitable equipment or techniques known in the art including single and multi-stage drying processes. For example, the coated wire may be dried at or above room temperature (e.g., about 20° C. to about 27° C. or about 25° C. at standard conditions). In embodiments, the coated wire is dried at a temperature below the boiling point of the highest boiling point solvent in the dope. The drying conditions may provide for a coated wire that is non-porous, porous, microporous, etc. In some embodiments, the coated wire is non-porous. Moreover, depending on the processing conditions and application, it may be desirable to wash out the higher boiling solvent(s) with lower boiling solvent(s) in order to provide for easier drying/processing conditions.

The coating may be formed to any suitable thickness depending on the desired application. If a thicker coating is required, the concentration of polymers may be increased. Additional coatings may be added until the desired thickness of the coating is achieved (i.e., the additional coatings may be comprised of a single or multiple layers). The additional coatings may be made by applying the same or different solution compositions (e.g., solutions having different polymer(s) and/or solvents). The additional coating(s) may be applied at any suitable time, e.g., after the initial coating has at least partially or fully dried. The total thickness of the layers of coating may range from, for example, about 1 nm to about 1500 μm.

The coatings may be selected so that different layers exhibit different properties. As an example, a first layer of a coated wire may comprise PEKK 60/40 and a second layer may comprise PEKK 80/20. These layers may be next to one another or separated by at least one additional layer(s). As another example, the layer closest to the wire core may be selected to enable a very good adhesion to the wire, whereas the outermost layer can be chosen so that it provides the highest chemical resistance or to provide for good adhesion between wires (e.g., to promote self-bonding in the manufacture of a coil).

In embodiments, the coated wire may comprise at least 5 ppm to 5000 ppm of a phenolic solvent.

Optionally, the resulting coated wire may also undergo suitable post-treatments known to one skilled in the art. For example, post-treatments, such as heating, exposure to electron-beam, may be used to develop specific properties in the coating, such as the polymer morphology, degree of crystallinity, mechanical properties, and chemical resistance.

The specialized coated wires described herein may be used for any suitable purpose. For example, potential applications include, but are not limited to, aerospace, aircraft, electronics, building and construction, photovoltaic, etc. The particular use of the coated wires is not especially limited.

The specialized coatings herein are expected to provide improved properties. In particular, the coatings have good retention of dielectric constant under various chemical and temperature environment, good mechanical properties including toughness, rigidity, durability, and strength. The coatings also exhibit good flame retardancy (e.g., as defined by the UL ratings), exhibit low sensitivity to moisture, have low defect content, and have good adhesion to the wires to which they are applied.

Methods of manufacturing a coated wire disclosed herein may comprise at least dissolving at least one polymer comprising a poly(aryl etherketone) in at least one phenolic solvent to form a solution, contacting the surface of a wire with the solution to form a coated wire having at least one layer of coating, drying the coated wire to evaporate at least some of the residual solvent, and optionally, repeating the contacting and drying. The optional repetition may enable the formation additional layers on the coated wire.

In some embodiments, the methods comprise evaporating at least 70% or at least 80 wt. % of the residual solvent, or more. In some embodiments, the methods comprise drying the coated wire to evaporate at least about 80 wt % of the solvent, such that the residual solvent after drying is about 20% or less. In some embodiments, the methods comprise evaporating at least 90, 95, or 99 wt. % of the residual solvent.

In some of the above embodiments, the methods comprise forming a coated wire having at least one coating, the coating comprising at least 50 wt. % of at least one poly(aryl etherketones), at least 60 wt. % of at least one poly(aryl etherketones), at least 70 wt. % of at least one poly(aryl etherketones), at least 80 wt. % of at least one poly(aryl etherketones), at least 90 wt. % of at least one poly(aryl etherketones), at least 95 wt. % of at least one poly(aryl etherketones), or at least 99% of at least one poly(aryl etherketones).

In some of the above embodiments, the one or more poly(aryl etherketones) may be selected from the group of polyetherketoneketones (PEKK), polyetheretherketones (PEEK), polyetherketones (PEK), polyetherketoneetherketoneketones (PEKEKK), or mixtures thereof comprise at least one of PEKK and/or PEEK.

In some of the above embodiments, the phenolic solvent comprises at least one solvent selected from the group of: 4-chloro-2-methyl phenol (4-cl-o-cresol), 4-chloro-3-methyl phenol (4-Cl-m-cresol), 3-chloro phenol, 4-chloro phenol, and 4-methyl phenol (p-cresol). In some of the above embodiments, the solvent may also comprise ortho dichlorobenzene (ODCB). In some such embodiments the phenolic solvent may comprise 4-chloro-3-methyl phenol and 4-chloro phenol, more particularly about 5 to 20 wt. %, about 5 to 15 wt. %, or about 10 wt. % 4-chloro-3-methyl phenol and about 80-95 wt. %, about 85 to 95 wt. %, or about 90 wt. % 4-chloro phenol. In some such embodiments the solvent may be comprised of a mixture of 4-chloro-phenol, 4-chloro-3-methyl phenol (4-Cl-m-cresol) and ortho dichlorobenzene (ODCB), including from about 5 weight percent to about 90 weight percent of 4-chloro-phenol, 0.5 to about 10 weight percent 4-chloro-3-methyl phenol (4-Cl-m-cresol) and 0 to about 90 weight percent ortho dichlorobenzene (ODCB), based on the total weight of the solvent.

In some of the above embodiments, the wire comprises a metallic core. In some embodiments, the wire comprises a core having at least 20 wt. % metal, at least 30% wt. metal, at least 50% wt. metal, at least 75% wt. metal, at least 90% wt. metal, at least 95 wt. % metal or at least 99 wt. % metal. In some of the above embodiments, the metal proportions are continuous throughout the wire core. In some of the above embodiments, the metal comprises at least one of copper, aluminum, and steel.

In some of the above embodiments, the wire comprises a primer. In some such embodiments, the primer comprises a polyamideimide. In some such embodiments, the primer comprises less than about 20 wt. % of the total coatings on the wire or less than about 10 wt. %, 5 wt. % or 1 wt. % of the total coatings on the wire.

In some of the above embodiments, the contacting the surface of a wire with the solution to form a coated wire comprises dipping the wire in the solution or spraying the wire with the solution.

In some of the above embodiments, the drying of the coated wire takes place at a temperature of about 250° C. to 420° C., preferably between 300° C. and 360° C.

In some of the above embodiments, the at least one layer of coating has a thickness of about 1 nm to 1500 μm in thickness or about 0.25 μm to about 250 μm in thickness. In some of the above embodiments, the thickness of the at least one layer of coating is within the range of 10 to 1500 μm, preferably 10 to 200 μm, more is preferably 10 to 60 μm.

In some of the above embodiments, the methods may further comprise contacting the surface of the coated wire having at least one layer of coating with a solution, being the same or different from the solution used to form the at least one layer, to form a multiply coated wire having at least two layers of coating, and drying the multiply-coated wire to evaporate residual solvent, for example, at least 70 wt. % of the residual solvent, at least 80 wt. % of the residual solvent, at least 90 wt. % of the residual solvent, at least 95% of the residual solvent, or at least 99 wt. % of the residual solvent.

In some of the above embodiments, the at least one polymer may be dissolved at or above room temperature (e.g., about 20° C. to about 27° C. or about 25° C. at standard conditions) or at elevated temperatures (e.g., about 75° C. to about 85° C.), or higher temperatures (e.g., about 145° C. to about 155° C.).

In some of the above embodiments, the coated wire may have a circular, oval, square or rectangular cross-section.

In some of the above embodiments, the method may further include filtering the one or more solutions to remove impurities prior to its contact with the wire.

Other embodiments of the present invention are directed to coated wires having cores and at least one layer of coating comprising a poly(aryl etherketone),wherein the coated wire is formed by a process of dissolving at least one polymer comprising a poly(aryl etherketone) in at least one phenolic solvent to form a solution; contacting the surface of a wire with the solution to form a coated wire having at least one layer of coating; and drying the coated wire toe evaporate residual solvent. In some of the embodiments, the coated wire may comprise at least two layers of coating, being the same or different from one another. In some such embodiments, the at least one polymer may comprise one or more poly (aryl etherketones) selected from polyetherketoneketones (PEKK), polyetheretherketones (PEEK), polyetherketones (PEK), polyetherketoneetherketoneketones (PEKEKK), or mixtures thereof. In some such embodiments, the at least one polymer may comprise PEKK and/or PEEK.

In some of the above embodiments directed to coated wires, the phenolic solvent may comprise at least one solvent selected from the group of: 4-chloro-2-methyl phenol (4-cl-o-cresol), 4-chloro-3-methyl phenol (4-Cl-m-cresol), 3-chloro phenol, 4-chloro phenol, and 4-methyl phenol (p-cresol).

In some of the above embodiments directed to coated wires, the phenolic solvent comprises at least one solvent selected from the group of: 4-chloro-2-methyl phenol (4-cl-o-cresol), 4-chloro-3-methyl phenol (4-Cl-m-cresol), 3-chloro phenol, 4-chloro phenol, and 4-methyl phenol (p-cresol). In such embodiments the phenolic solvent may comprise 4-chloro-3-methyl phenol and 4-chloro phenol, more particularly about 5 to 20 wt. %, about 5 to 15 wt. %, or about 10 wt. % 4-chloro-3-methyl phenol and about 80-95 wt. %, about 85 to 95 wt. %, or about 90 wt. % 4-chloro phenol.

In some of the above embodiments directed to coated wires, the wire comprises a metallic core. In some embodiments, the wire comprises a core having at least 20 wt. % metal, at least 30% wt. metal, at least 50% wt. metal, at least 75% wt. metal, at least 90% wt. metal, at least 95 wt. % metal or at least 99 wt. % metal. In some of the above embodiments, the metal comprises at least one of copper, aluminum, and steel.

In some of the above embodiments directed to coated wires, the coated wire may have a circular, oval, square or rectangular cross-section.

In some of the above embodiments directed to coated wires, the coated wire may be used as magnet wire (i.e., used in an electromagnetic coil of, for instance, an electric motor).

In some of the above embodiments directed to coated wires, an electric motor may comprise the coated wire.

Embodiments described herein include a coated wire comprising: a metallic core of at least 20 wt. % metal; at least one layer of coating surrounding the metallic core, the coating comprising a poly(aryl etherketone); and at least 5 ppm to 5000 ppm of a phenolic solvent.

While certain embodiments of the invention have been shown and described herein, it will be understood that such embodiments are provided by way of example only without departing from the spirit of the invention. Accordingly, it is intended that the appended claims cover all such variations as fall within the spirit and scope of the invention. Numerous variations, changes and substitutions will occur to those is skilled in the art.

1. A method of manufacturing a coated wire, the method comprising:
dissolving at least one polymer comprising a poly(aryl etherketone) in at least one phenolic solvent to form a solution;
contacting the surface of a wire with the solution to form a coated wire having at least one layer of coating; and
drying the coated wire to evaporate at least about 80 wt % of the solvent, such that the residual solvent after drying is about 20% or less.
optionally, repeating contacting and drying.

2. A method of manufacturing a coated wire according to claim 1, wherein the at least one polymer comprises one or more poly(aryl ketones) selected from polyetherketoneketones (PEKK), polyetheretherketones (PEEK), polyetherketones (PEK), polyetherketoneetherketoneketones (PEKEKK), or mixtures thereof.

3. A method of manufacturing a coated wire according to claim 2, wherein the at least one polymer comprises PEKK and/or PEEK.

4. A method of manufacturing a coated wire according to claim 1, wherein the phenolic solvent comprises at least one solvent selected from the group of: 4-chloro-2-methyl phenol (4-cl-o-cresol), 4-chloro-3-methyl phenol (4-Cl-m-cresol), 3-chloro phenol, 4-chloro phenol, and 4-methyl phenol (p-cresol).

5. A method of manufacturing a coated wire according to claim 4, wherein the phenolic solvent comprises 4-chloro-3-methyl phenol and 4-chloro phenol.

6. A method of manufacturing a coated wire according to claim 5, wherein the phenolic solvent comprises about 5 to 20% 4-chloro-3-methyl phenol and about 80 to 95% 4-chloro phenol.

7. A method of manufacturing a coated wire according to claim 1, wherein the wire comprises copper, aluminum or steel.

8. A method of manufacturing a coated wire according to claim 7, wherein the surface of the wire comprises a primer.

9. A method of manufacturing a coated wire according to claim 1, wherein contacting the surface of a wire with the solution to form a coated wire comprises dipping the wire into the solution or spraying the wire with the solution.

10. A method of manufacturing a coated wire according to claim 1, wherein drying the coated wire takes place at a temperature of 250° C. to 420° C.

11. A method of manufacturing a coated wire according to claim 1, wherein the at least one layer of coating has a thickness of about 0.5 to 2 microns.

12. A method of manufacturing a coated wire according to claim 1, comprising:
contacting the surface of the coated wire with the solution to form a multiply-coated wire having at least two layers of coating; and
drying the multiply-coated wire to evaporate residual solvent.

13. A method of manufacturing a coated wire according to claim 1, wherein the at least one polymer is dissolved at or above room temperature.

14. A method of manufacturing a coated wire according to claim 1, wherein the at least one coated wire has a circular, oval, square or rectangular cross-section.

15. A method of manufacturing a coated wire according to claim 1, comprising:
filtering the solution to remove impurities.

16. A coated wire having a core and at least one layer of coating comprising a poly(aryl ketone), wherein the coated wire is formed by a process of:
dissolving at least one polymer comprising a poly(aryl etherketone) in at least one phenolic solvent to form a solution;
contacting the surface of a wire with the solution to form a coated wire having at least one layer of coating; and
drying the coated wire to evaporate residual solvent.

17. The coated wire of claim 16, comprising at least two layers of coating.

18. The coated wire of claim 17, wherein a first layer of coating has a different composition than a second layer of coating.

19. The coated wire of claim 16, wherein the at least one polymer comprises one or more poly(aryl ketones) selected from polyetherketoneketones (PEKK), polyetheretherketones (PEEK), polyetherketones (PEK), polyetherketoneetherketoneketones (PEKEKK), or mixtures thereof.

20. The coated wire of claim 19, wherein the at least one polymer comprises PEKK and/or PEEK.

21. The coated wire of claim 16, wherein the phenolic solvent comprises at least one solvent selected from the group of: 4-chloro-2-methyl phenol (4-cl-o-cresol), 4-chloro-3-methyl phenol (4-Cl-m-cresol), 3-chloro phenol, 4-chloro phenol, and 4-methyl phenol (p-cresol).

22. The coated wire of claim 21, wherein the phenolic solvent comprises 4-chloro-3-methyl phenol and 4-chloro phenol.

23. The coated wire of claim 22, wherein the phenolic solvent comprises about 5 to 20% 4-chloro-3-methyl phenol and about 80 to 95% 4-chloro phenol.

24. The coated wire of claim 23, wherein the core comprises aluminum, copper or steel.

25. The coated wire of claim 16, used as a magnet wire in an electromagnetic coil.

26. An electric motor comprising the magnet wire of claim 25.

27. An electric motor comprising the coated wire of claim 16.

28. A coated wire comprising:
a metallic core of at least 20 wt. % metal;
at least one layer of coating surrounding the metallic core, the coating comprising a poly(aryl etherketone); and
at least 5 ppm to 5000 ppm of a phenolic solvent.
